(19) United States
(12) Patent Application Publication
(10) Pub. No.: US 2014/0136375 A1
(43) Pub. Date: May 15, 2014

(54) METHOD AND SYSTEM FOR RISK AND CONSTRAINT BASED PRICING MODEL OF A CATALOG SERVICE TO ASSESS ENTERPRISE NETWORK TRANSFORMATION

(71) Applicants: Mukta Agarwal, Noida (IN); Shashidhar Krishnamurthy, Noida (IN); Shailender Govil, Noida (IN)

(72) Inventors: Mukta Agarwal, Noida (IN); Shashidhar Krishnamurthy, Noida (IN); Shailender Govil, Noida (IN)

(21) Appl. No.: 13/674,111

(22) Filed: Nov. 12, 2012

(51) Int. Cl. G06Q 30/00

(52) U.S. Cl. 705/27.1

(57) ABSTRACT

A method and system for risk and constraint based pricing model of a catalog service to assess enterprise network transformation. The embodiments herein disclose a method and system for risk and constraint based pricing model of a catalog service to assess the enterprise network transformation. The pricing of the effort is estimated by counting the effort to fulfill a service request and adding the total cost of the tool used to execute the service. The comprises of two price points which are factored with size of enterprise stack, along with constraints and risk related to the enterprise information The pricing engine running on processor interfaces with the network for communicating with its sub-processing units. The pricing engine running on processor interfaces with user through the software defined user interface through its hardware Input/output module.

This application claims priority from Indian application 4707/CHE/2012 titled “Method and System for Risk and Constraint Based Pricing Model of a Catalog Service to Assess Enterprise Network Transformation” and filed on Nov. 9, 2012.

### TECHNICAL FIELD

The embodiments herein relate to cost estimation and, more particularly, to cost estimation in enterprise stack.

### BACKGROUND

The expansion of information processing solutions essential to a business enterprise has provided an opportunity to apply the advantages of software processing technology to almost every area of the enterprise and accordingly enhance customer value in a more efficient manner. As Information Technology (IT) continues to grow throughout the enterprise, the demand for IT services has also proportionally expanded. However, current IT estimation techniques are simplistic in nature and are not well suited for generating precise estimates for service oriented projects.

IT solution providers continue to be increasingly challenged by encounters with potential customers utilizing technologies which are outside the traditional areas supported by the providers. Moreover, IT lifecycle processes are configured to managing self contained solutions. Concurrently, with the ever changing needs of conducting IT professional services (beyond software development price), it is necessary to complete the professional projects on time and within the stipulated budget. The accurate estimation of the person effort, assessment of risks involved, issues involved in conducting the service, along with the physical network and security topologies help in arriving at estimation of the project costs involved. This estimation assists in realizing the schedule or time line while accomplishing the tasks within the stipulated budget.

By assessing the project cost and estimated efforts beforehand, it helps an enterprise to keep track of the actual costs involved and efforts during and/or after project execution. Since, these projects are quite different than standard software development projects, estimation methods like Constructive Cost Model (COCOMO) or Function point analysis do not match up to the current needs.

In an existing method, a project resource quantification tool is adapted to estimate required amount of components for completing a construction project. An input receives an electronic image data file and an image feature. The image feature has a classification based on correspondence of the image feature to a type of project resource, such as a type of component and/or connectivity material. Though the method counts the project's requirement and adds up the cost of the estimation, it has limitations which include being unable to assess the enterprise network along with not considering important factors like price of the effort, size of the enterprise stack, constraints and risks.

In another existing method, a service selection tool including an input component is configured to gather service requirements of a shared service project. Further, an analysis component is configured to compare the set of candidate shared services. Though the method counts the candidate services and adds the total cost of the service selection tool, it does not consider essential factors such as size, constraints and risks.

From the above mentioned reasons, there appears to be a need for a method which effectively estimates pricing of a catalog service for an enterprise network transformation and is an adaptive model to enhance the service pricing.

### SUMMARY

Accordingly the embodiments provides a computer-implemented method to estimate pricing of a catalog service for assessing the enterprise network transformation, wherein the method comprises creating catalog service requirement document (CSRD) and receiving a request for the service from a user. The method further comprises mapping the request to the created document by a user interface and estimates price of effort required to execute the service based on parameters by an analysis module. Furthermore, the method comprises estimating price of tool used to execute the request based on parameters and to determine total price of the catalog service based on the price of effort and the price of tool by an analysis module.

Accordingly the embodiments provides a system to estimate pricing of a catalog service for assessing the enterprise network transformation, wherein the system comprises a user interface (UI) module and an analysis module. The system further comprises an integrated circuit comprising at least one processor with a memory having a computer program code within a circuit. Further, the system is configured to create a catalog service requirement document (CSRD).

### BRIEF DESCRIPTION OF THE FIGURES

The embodiments herein will be better understood from the following detailed description with reference to the drawings, in which:

FIG. 1 is a functional block diagram of a catalog service pricing module, according to the embodiments disclosed herein;

FIGS. 2A and 2b are flow diagrams illustrating the pricing of catalog service, according to the embodiments disclosed herein; and

FIG. 3 is a block diagram illustrating the computer implementation of catalog service pricing, according to the embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

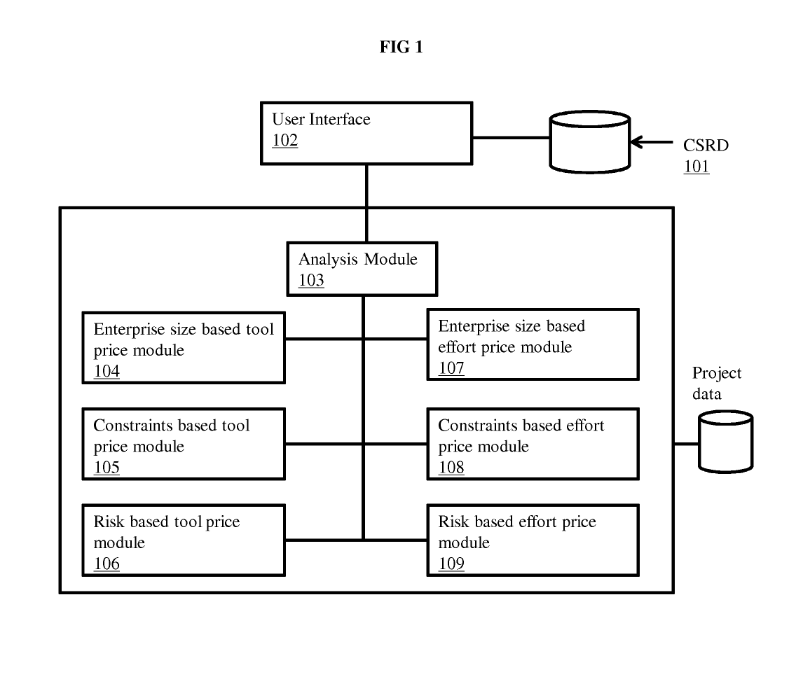

The embodiments herein disclose a method to estimate the cost of assessment service of an enterprise network by implementing a risk and constraint based pricing model. Referring now to the drawings, and more particularly to FIGS. 1 through 3, where similar reference characters denote corresponding features consistently throughout the figures, there are shown embodiments.

FIG. 1 illustrates a functional block diagram of a catalog service pricing module, according to the embodiments disclosed herein. As depicted in FIG. 1, the catalog service pricing module comprises of a User Interface (UI) 102, Catalog Service Requirement Document 102, and the Analysis module 103. The Analysis module 103 comprises of plurality of pricing engines such as enterprise size based tool price module 104, constraints based tool price module 105, risk based tool price module 106, enterprise size based effort price module 107, constraints based effort price module 108, and risk based tool price module 109. Two price points are factored with the size of enterprise stack and constraints and risk related to the enterprise information. The size of enterprise stack along with the constraints and risk related to the enterprise information constitute the service request execution environment.

Pricing model is the method to assess a price point to execute professional services in IT industry which is beyond product/software engineering. Catalog service is a service which is beyond the product/software development engineering work in IT industry. Catalog service is the service which is rendered to a client and is function of manpower to execute certain tools. Further, the output of this service (is not a software code or embedded product) is primarily a set of services which can be reported in terms of provisioning, generating an assessment report, conducting on job training, and testing the functioning of system(s) in an environment. The end user of the catalog service is an enterprise which uses the service.

A catalog service typically includes factors such as description of the service, timeframes for fulfilling the service, costs, who is entitled to request/view the service, and how to fulfill the service. Consider a case of a user's perspective using the catalog service. A user goes to a website to search for a specific service, such as requesting a new laptop, requesting a change in benefits and so on. The catalog service site groups service by category and allows for searching (especially when hundreds or thousands of services are available). The user selects a desired service and sees the description and details. The user enters any pertinent information (contact information, service-specific questions) and submits the request for service. The request requires approval, and goes through routing, service-level management, and other processes necessary to fulfill the request. The user may return to the site later to check on the status of a request, or to view overall metrics on how well the organization is performing the services it provides.

Consider a case of business manager's respective. Business Unit Managers determine what services to “publish” to end-users via the catalog service. Business Unit Managers and Analysts may determine what questions are to be asked of the user; any approvals necessary for a request, and what other systems or processes are needed to fulfill the request. Once the service is defined and the fulfillment process organized, these people or a more technical employee build the requisite functionality into the service definition and then publish this to the service catalog.

The pricing model and tool helps to define a structured approach to assess the assumptions on a project execution environment. The business advantage is passed to the end user (enterprise) by including a significantly higher competitive pricing. The two main pricing components are defined as follows:
1. The price of the effort required to execute the service. This price also considers any effort arising out of additional factors like size of the enterprise stack, constraints and risks associated with enterprise related information.
2. The price of the tool used to execute the request. This price is the proportional price of the tool based on usage rather than monolithic license price of the tool. This pricing of tool considers factors such as the size of enterprise stack, enterprise related constraints like demography, network topology, security guidelines, government and regulatory compliance and other risks associated with enterprise related information. Since these factors are considered, it helps to differentiate the usage of pricing tool and raises different set of risk factors upon usage of tools. These factors needs to be augmented either by customizing the tool or its usage and/or ways of deployment or execution of the pricing tool. The pricing tool helps to tabulate the different sizes of enterprise stack and associated infrastructural elements (as depicted in Table 1). Further, the pricing tools helps tabulate the different sizes of enterprise stack and associated infrastructural elements. The pricing tool also allows factoring of usage of tool and effort to execute the service.

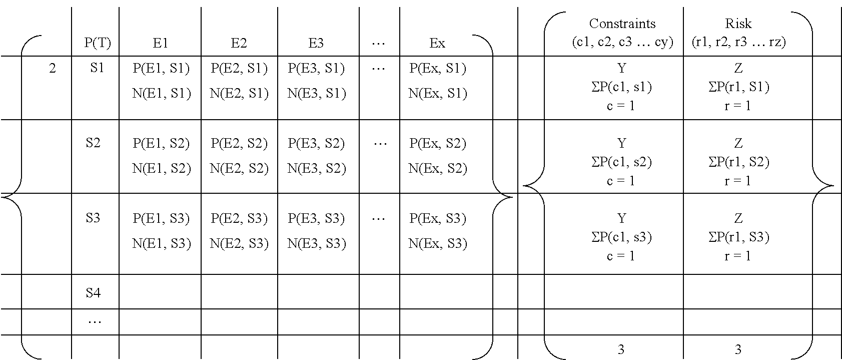

The pricing model helps to tabulate all the constraints and risks such as type and nature of infrastructural elements. The infrastructural elements include but are not limited to hardware/software, Commercially off the shelf System (COTS)/Operating System (OS) or network topology/accessibility, security design and policies, location and mode of execution.

As depicted in FIG. 1, the catalog service flows to the company and a service request is triggered by a customer Request for Proposal (RFP). The service requirement is mapped to the CSRD 101. The CSRD 101 comprises information about the service request, enterprise environment and service related information. Based on CSRD 101, the relevant enterprise size, constraints and risk related information are derived and fed into the Catalog service pricing module via the UI 102 through a manual process. Further, the information is passed to an Analysis Module 103 for generating the relevant triggers to plurality of pricing modules. The plurality of pricing modules uses the project data and all current and heuristic information available to calibrate the final pricing of the catalog service.

In an embodiment, the project data includes the service rates dependent on service locations, risk management, constraint factors related pricing details, the project execution plan (phase-wise) and service request historical data.

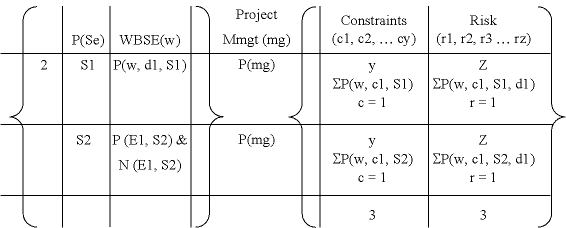

The above table (table 2) depicts the service pricing table involving constraints, risks and execution efforts. The following equations indicate the output generated by the pricing tools:

$$\begin{matrix}P ( T ) = {\sum }_{E = 1}^{x} P ( E , S ) * N ( E , S ) + {\sum }_{c = 1}^{y} P ( c , S ) + {\sum }_{r = 1}^{z} P ( r , S ) - & ( 1 ) \\ P ( Se ) = P ( w , dl , S ) + P ( mg ) + {\sum }_{c = 1}^{y} P ( w , c , S , dl ) + {\sum }_{r = 1}^{z} P ( w , r , S , dl ) & ( 2 ) \\ P ( CS ) = P ( T ) + P ( Se ) & ( 3 )\end{matrix}$$

Following are the definitions based on equations of the method.
1. Element (E) is defined as the type of elements in the enterprise (hardware infrastructure elements, unique application and services running on servers)
2. Number of elements (N) is defined as the number of each type of elements (E) in the enterprise.
3. Tool (T/t) is defined as the tool which is used to perform the service.
4. Catalog service (CS) is defined as the service which is rendered to a customer.
5. Constraints (c) are defined as the constraints arising out of enterprise size, network design and security guidelines.
6. Risk (r) is defined as the risks based on enterprise size, demography and security guidelines.
7. Size (s) is defined as the size of enterprise in terms of number of elements.
8. Service effort (Se) is defined as the effort to render the catalog service.
9. WBSE (w) is defined as the Work Breakdown Structure (WBS) effort to render the service.
10. Demographic Location (dl) is defined as the location out of which service may be rendered.

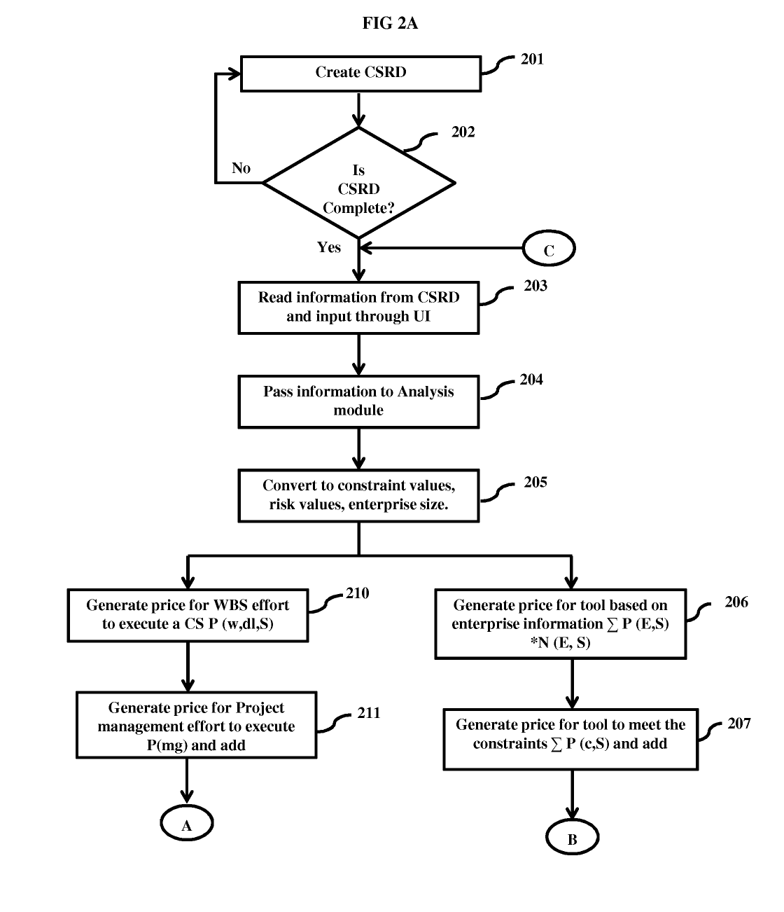

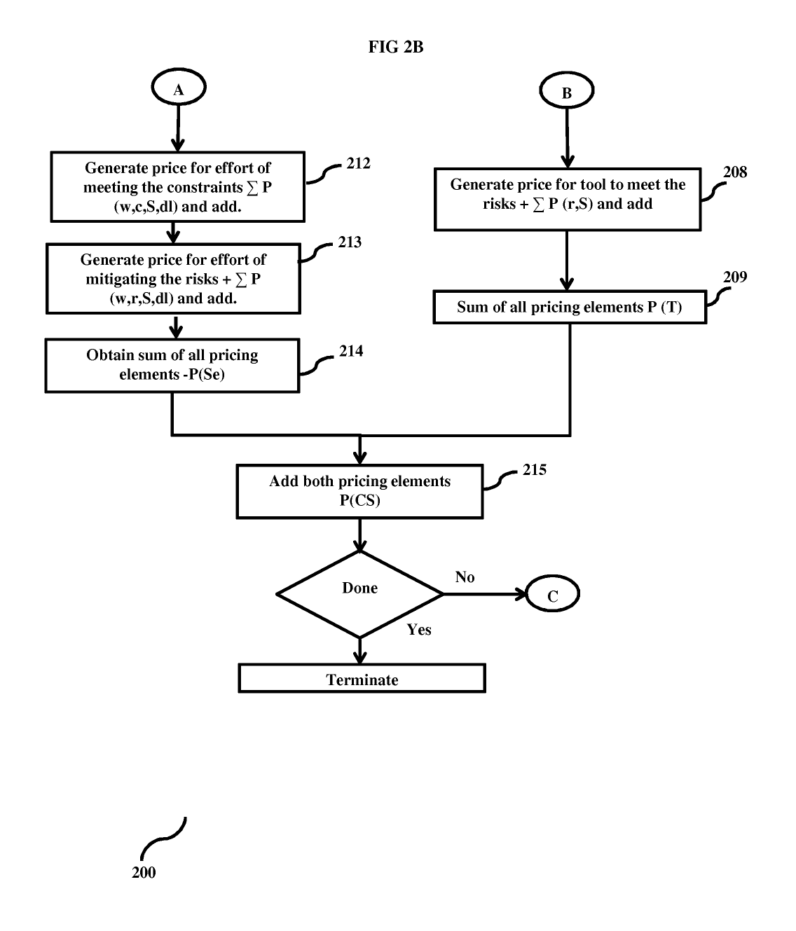

FIGS. 2A and 2b are flow diagrams illustrating the pricing of catalog service, according to the embodiments disclosed herein. As depicted in FIGS. 2A and 2B, initially a Catalog Service Requirement Document (CSRD) is created (201).The CSRD comprises information about the service request, enterprise environment and service related information. A check is performed (202) to find out if the CSRD has been completed. If not, the CSRD has to be created in order to further proceed. Once the CSRD is completed, information is read from CSRD and input is fed (203) through UI 102. Further, the information is passed (204) to the Analysis Module 103. The information is processed by the Analysis Module 103 using CSRD and project data. The information is converted (205) to constraint values, risk values and enterprise size.

Further, the price is generated (206) for the tool based on enterprise information and the price is generated (207) for the tool to meet the constraints. Furthermore, the price is generated (208) for the tool to meet the risks and eventually the sum of all pricing elements (pricing effort) is obtained (209). The price is generated (210) for WBS effort to execute a Catalog Service (CS) and the price is also generated (211) for project management effort to execute. The price is further generated (212) for effort of meeting the constraints and the price is also generated (213) for effort of mitigating the risks. The sum of all pricing elements P (se) that is the service effort is obtained (214). The sum of service effort elements and the sum of pricing effort elements are added (215) finally. The various actions in method 200 may be performed in the order presented, in a different order or simultaneously. Further, in some embodiments, some actions listed in FIG. 2 may be omitted.

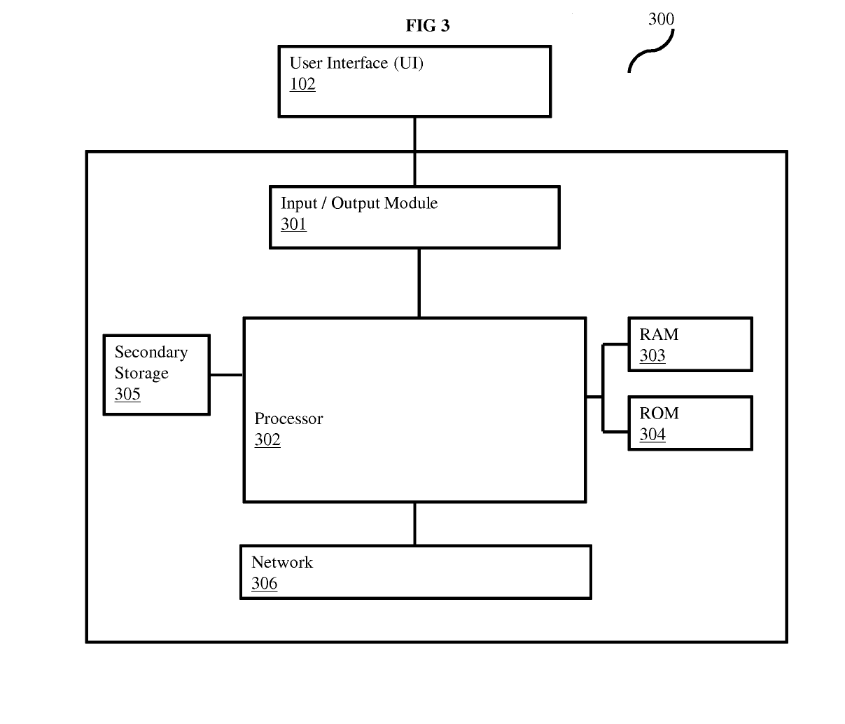

FIG. 3 is a block diagram illustrating the computer implementation of catalog service pricing, according to the embodiments disclosed herein. As depicted in FIG. 3, the computer implementation of catalog service pricing comprises of modules such as the UI 102, Input/Output module 301, Processor 302, Random Access Memory module 303, Read only memory module 304, and secondary storage module 305. The implementation of catalog service pricing module logic lies in the processor 302. The pricing module running on processor interfaces with the network for communicating with the sub processing units. The pricing module running on the processor 302 interfaces with user through the software defined user interface through its hardware I/0 module 301 which is displayed.

The enterprise stack is formed by three layers:
a. Infrastructure layer (hardware layer): Networking, security gears, enterprise servers, storage gears, endpoint devices.
b. COTS/Open Source Software (OSC): This is the software running on servers/endpoints behind the firewall in data center and/or De-militarized Zone (DMZ).
c. In-house/proprietary/custom-built software running on servers and/or endpoint devices. The pricing method uses the aspects of enterprise stack and constraints arising out of demography, networking and security guidelines.

The pricing method uses the risks associated to exclude the service which arises out of organizational, human, social and other logistics. Further, the pricing method monetizes a tool such as the Analysis module 103 to perform the service and assesses person hours to perform the service. The pricing method comprises of the calibration of the person hours effort and calculation of the price for the Analysis module 103. By implementing the pricing method, the service request estimation and pricing is defined and covered by a system and algorithm. Thus, it helps the company and clients to prepare and receive faster response to the service request. Further, the mathematical implementation of the pricing method removes the people aspect of estimation and pricing to assume data and related information. Since all pricing elements are known beforehand, the project manager may predict and control the service quality while monitoring the project margins from the start. The pricing model uses heuristic data, therefore it will be self learning and adaptive from previous service requests.

The embodiments disclosed herein can be implemented through at least one software program running on at least one hardware device and performing network management functions to control the network elements. The network elements shown in FIGS. 1 and 3 include blocks which can be at least one of a hardware device, or a combination of hardware device and software module.

The embodiment disclosed herein specifies a system for IT estimation modeling and pricing of assessment service of an enterprise. The mechanism allows analyzing the service request and estimation of the service needs providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiments may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A computer-implemented method to estimate pricing of a catalog service for assessing the enterprise network transformation, wherein said method comprises:
creating catalog service requirement document (CSRD);
receiving a request for said service from a user;
mapping said request to said created document by a user interface;
estimating price of effort required to execute said service based on parameters by an analysis module;
estimating price of tool used to execute said request based on parameters by said analysis module; and
determining total price of said catalog service based on said price of effort and said price of tool by said analysis module.

2. The computer-implemented method as in claim 1, wherein said method estimates pricing of said catalogue service based on at least one of: risk, constraint based pricing.

3. The computer-implemented method as in claim 1, wherein said parameters comprises at least one of: enterprise stack said risk and said constraints.

4. The computer-implemented method as in claim 3, wherein said constraints comprises at least one of: demographics; security policies; enterprise size; and network design to execute the project.

5. The computer-implemented method as in claim 3, wherein said risk comprises at least one of: organizational risk; human risk; social risk; and logistics risk.

6. A system to estimate pricing of a catalog service for assessing the enterprise network transformation, wherein said system comprises a user interface (UI) module, analysis module, further said system comprises:
an integrated circuit further comprising at least one processor;
at least one memory having a computer program code within said circuit;
said at least one memory and said computer program code configured to with said at least one processor cause said system to:
create catalog service requirement document (CSRD);
receive a request for said service from a user;
map said request to said created document by said user interface;
estimate price of effort required to execute said service based on parameters by said analysis module;
estimate price of tool used to execute said request based on parameters by said analysis module; and
determine total price of said catalog service based on said price of effort and said price of tool by said analysis module.

7. The system as in claim 6, wherein said analysis module comprises at least one of: enterprise size based tool price module; enterprise size based effort module;
constraints based tool price module; constraints based effort price module; risk based tool price module; and risk based effort price module.

8. The system as in claim 6, wherein said system is configured to estimate said at least one of: price of effort, price of tool based on parameters, wherein said parameters comprises at least one of: enterprise size; constraints related information; and
risks associated with said size and said constraints.

9. The system as in claim 8, wherein said system is configured to estimate said price of effort by at least one of: size of the enterprise stack, said constraints and risks associated with enterprise related information for mitigating said risk.

10. The system as in claim 9, wherein said system is configured to generate said price of effort for at least one of: project management, meeting said constraints, mitigating said risks.

11. The system as in claim 6, wherein said system is configured to calibrate said parameters for assessing person hours to perform said service.

12. The system as in claim 6, wherein said system is configured to estimate project cost of said service by adding said price of tool, and said person hours to complete said service.

13. The system as in claim 6, wherein said analysis module is configured to map said request to said document and convert said request to said at least one of:
constraints values, risk values and enterprise size.

14. The system as in claim 13, wherein said system is configured to estimate said enterprise size by said at least one of: enterprise size based tool price module, and enterprise size based effort module.

15. The system as in claim 13, wherein said system is configured to estimate said constraints values by said at least one of: constraints based tool price module, and constraints based effort price module.

16. The system as in claim 13, wherein said system is configured to estimate said risk values by said at least one of: risk based tool price module and risk based effort price module.
